(19) United States
(12) Patent Application Publication
(10) Pub. No.: US 2008/0155490 A1
(43) Pub. Date: Jun. 26, 2008

(54) Method for Reducing Coupling Noise, Reducing Signal Skew, and Saving Layout Area for an Integrated Circuit

(76) Inventors: Tianwen Tang, Fremont, CA (US); Raghunath Vutukuru, San Jose, CA (US); Chao-Cheng Yeh, Fremont, CA (US)

Correspondence Address: MCANDREWS HELD & MALLOY, LTD, 500 WEST MADISON STREET, SUITE 3400, CHICAGO, IL, 60661, US

(21) Appl. No.: 11/615,270

(22) Filed: Dec. 22, 2006

(51) Int. Cl. G06F 17/50

(52) U.S. Cl. 716/11; 716/12

(57) ABSTRACT

Methods for reducing coupling noise, reducing signal skew, and saving layout area for an integrated circuit. Aspects of one method may include prioritizing a plurality of clock signals for layout on a chip. The clock signals may comprise functional and test clock signals and test clock signals, where the functional and test clock signals may not both be active at the same time. The clock signals may be routed based on the prioritization, where the priority may be based on, for example, frequency and/or slew rate of each clock signal. A route guide may also be used to take into account an amount of cross-talk reduction desired for each clock signal and/or whether a metal layer may be used may also be used in routing the clock signals. The clocks signals may also be routed so that the functional clock signals may be interlaced with the test clock signals.

### CROSS-REFERENCE TO RELATED APPLICATIONS/INCORPORATION BY REFERENCE

[Not Applicable]

### FEDERALLY SPONSORED RESEARCH OR DEVELOPMENT

Not Applicable]

### MICROFICHE/COPYRIGHT REFERENCE

[Not Applicable]

### FIELD OF THE INVENTION

Certain embodiments of the invention relate to chip design. More specifically, certain embodiments of the invention relate to a method for reducing coupling noise, reducing signal skew, and saving layout area for an integrated circuit.

### BACKGROUND OF THE INVENTION

Integrated circuits and PC boards with high-density layout and correspondingly narrow layout spacing create an engineering problem—the increased probably of noise, crosstalk and signal integrity issues. Narrow layout spacing between high-speed signal lines creates the possibility that signals from one line will bleed through to an adjacent line, sometimes referred to as interactions between “aggressors” and “victims.” This increase in noise can result in false logic triggers.

Integrated circuits and circuit boards typically also require clock signals for operation. The clock signals may be used for operation of synchronous logic, for example. As technology advances to allow design of more complex circuitry and to allow more logic to be laid out on a given area of a board or a chip, the number clock signal traces and/or the frequencies of those clock signals may increase. Accordingly, the traces laid out for clock signals and/or logic signals may be close enough to each other that noise may be coupled between two clock signals, between a clock signal and a logic signal, or between two logic signals. One way to compensate for noise on a clock signal may be to have the clock signals buffered by clock buffers. However, this may introduce unwanted timing skew between different clock signals.

Further limitations and disadvantages of conventional and traditional approaches will become apparent to one of skill in the art, through comparison of such approaches with some aspects of the present invention as set forth in the remainder of the present application with reference to the drawings.

### BRIEF SUMMARY OF THE INVENTION

A method for reducing coupling noise, reducing signal skew, and saving layout area for an integrated circuit, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an exemplary clock signal net in an integrated circuit, which may be utilized in connection with an embodiment of the invention.

FIG. 2A illustrates an exemplary timing diagram for clock signals in an integrated circuit, which may be utilized in connection with an embodiment of the invention.

FIG. 2B illustrates an exemplary timing diagram for slew rate for a clock signal in an integrated circuit.

FIG. 3 is a block diagram illustrating an exemplary clock signal net in an integrated circuit, which may be utilized in connection with an embodiment of the invention.

FIG. 4A illustrates an exemplary timing diagram for clock signals in an integrated circuit.

FIG. 4B illustrates an exemplary timing diagram for clock signals in an integrated circuit.

FIG. 5 illustrates an exemplary layout of clock signal paths in an integrated circuit, in accordance with an embodiment of the invention.

FIG. 6 is a flow chart illustrating exemplary steps for reducing coupling noise, reducing signal skew, and saving layout area, in accordance with an embodiment of the invention.

FIG. 7 is a block diagram of an exemplary processing system that may be used to lay out an integrated circuit, in accordance with an embodiment of the invention.

### DETAILED DESCRIPTION OF THE INVENTION

Certain embodiments of the invention may be found in a method for reducing coupling noise, reducing signal skew, and saving layout area for an integrated circuit. Aspects of the method may comprise prioritizing a plurality of clock signals for layout on a chip. The clock signals may comprise functional clock signals and test clock signals, where the functional clock signals may be inactive for at least a portion of time when the test clock signals are active. Similarly, the test clock signals may be inactive for at least a portion of time when the functional clock signals are active. The clock signals may be routed based on the prioritization, where the priority may be based on, for example, a frequency and/or a slew rate of each clock signal. A route guide may also be used in routing the clock signals. The route guide may, for example, take into account the amount of cross-talk reduction desired for each clock signal and/or whether a metal layer may be used for routing.

The clocks signals may be routed, for example, such that the functional clock signals may be interlaced with the test clock signals. Accordingly, the functional clock signals and the test clock signals may help isolate each other from interfering signals. The clock signals having a higher priority may be routed before a clock signal with a lower priority. Accordingly, the higher priority clock signals may have shorter paths than the lower priority clock signals. The functional clock signals may also be assigned a higher priority than the test clock signal. However, if the clock signals are interlaced, a portion of the functional clock signals may be routed then a portion of the test clock signals. In this manner, the functional clock signals and the test clock signals may be interlaced.

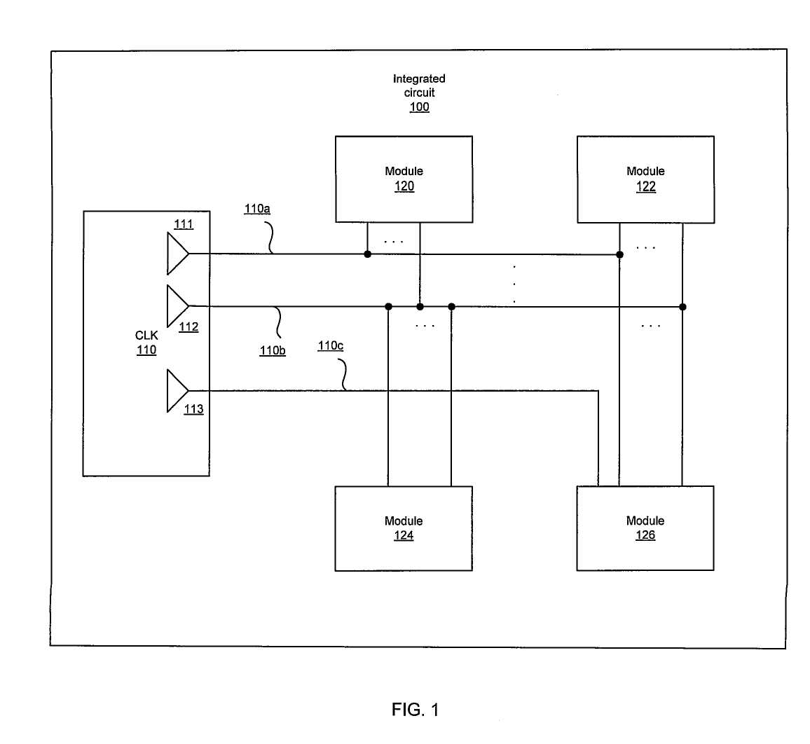

FIG. 1 is a block diagram illustrating an exemplary clock signal net in an integrated circuit, which may be utilized in connection with an embodiment of the invention. Referring to FIG. 1, there is shown an integrated circuit (chip) 100 that may comprise a clock generation block 110, and a plurality of circuit modules 120, 122, 124, . . . 126. The clock generation block 110 may comprise suitable logic, circuitry, and/or code that may enable generation of a plurality of clock signals 110a . . . 110b, 110c. The clock generation block 110 may comprise, for example, buffers 111, 112, and 113. The clock signals 110a . . . 110b may be communicated to the circuit modules 120, 122, 124, . . . 126, and the clock signal 110c may be communicated to the circuit module 126. Although the exemplary clock signals 110a . . . 110b may be shown as being communicated to the circuit modules 120, 122, 124, . . . 126, a clock signal may not be routed to those circuit modules that do not use those clock signals. For example, the clock signal 110a may be communicated to the circuit modules 120, 122, 124, . . . 126, while the clock signal 110b may be communicated to the circuit modules 122, 124, . . . 126 if the circuit module 120 does not use the clock signal 110b. Similarly, the clock signal 110c may be routed to other circuit modules that may need the clock signal 110c.

The clock signals 110a . . . 110b, 110c may comprise functional clock signals and test clock signals. Functional clock signals may be active when the integrated circuit 100 may be functioning in a normal mode. The normal mode may comprise periods when the integrated circuit 100 may be, for example, operating to support cellular communication for a mobile terminal user. Test clock signals may be active when the integrated circuit 100 may be functioning in a test mode. The test mode may comprise, for example, periods when the integrated circuit may be tested to verify correct functionality as part of a manufacturing process for the integrated circuit 100 and/or a device that the integrated circuit 100 may be a part of. During the normal mode, the test clock signals may not be active while the functional clock signals may be active, and during the test mode, the functional clock signals may not be active while the test clock signals may be active.

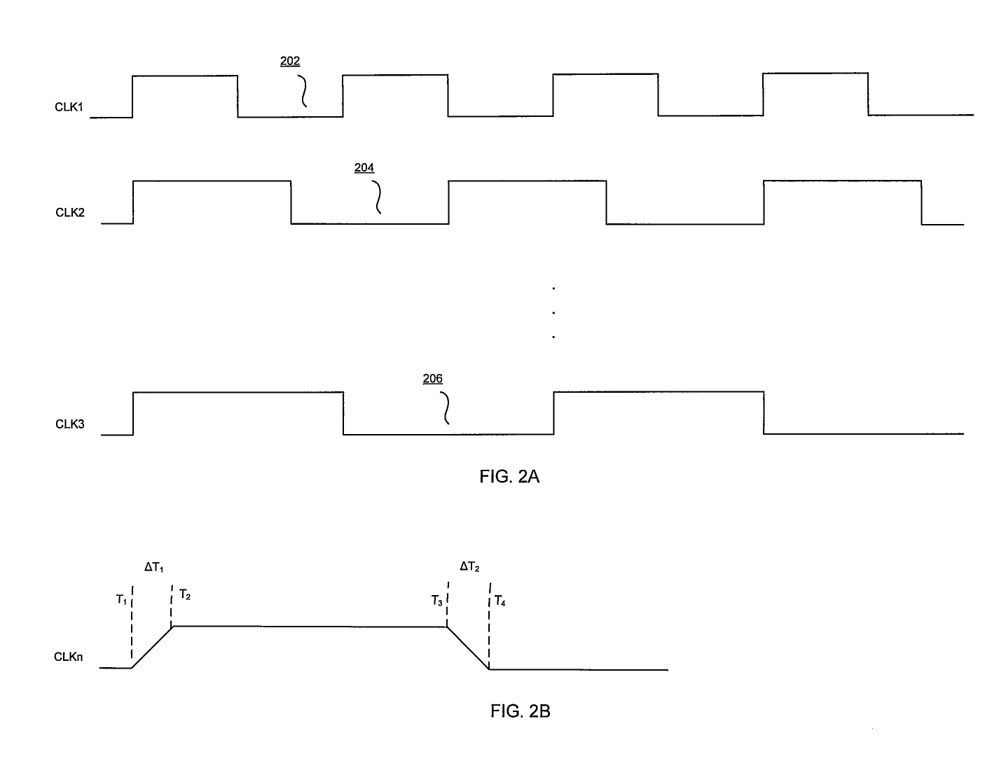

FIG. 2A illustrates an exemplary timing diagram for clock signals in an integrated circuit, in accordance with an embodiment of the invention. Referring to FIG. 2A, there is shown timing diagrams for the clock signals CLK1 202, CLK2 204, and CLK3 206. The clock signals CLK1 202, CLK2 204, and CLK3 206 may each have a different frequency. For example, if the clock signal CLK1 202 has a frequency of 4×, the clock signal CLK2 204 may have a frequency of 3×, and the clock signal CLK3 206 may have a frequency of 2×. Accordingly, if a clock frequency is used to determine priority of clock signals for routing on an integrated circuit, the clock signal CLK1 202 may have a higher priority than the clock signal CLK2 204, and the clock signal CLK2 206 may have a higher priority than the clock signal CLK3 206. Higher frequency signals may be accorded higher priority for routing because they may interfere more with signals on other traces than lower frequency signals. For example, allocating a higher priority to a high frequency clock than to other lower frequency signals may allow the high frequency clock to be laid out in a shorter and/or straighter path, and/or isolated from other signals. The shorter layout path may reduce interference with other signals, as well as reducing clock delay to various functional blocks that may use the high frequency clock. A straighter path may reduce signal ringing and/or radiation at corners where the path may change directions. Isolation may comprise, for example, placing other traces between the priority signals and other signals.

FIG. 2B illustrates an exemplary timing diagram for slew rate for a clock signal in an integrated circuit. Referring to FIG. 2B, there is shown a clock signal CLKn with a rise time of ΔT₁ and a fall time of ΔT₂. For a given voltage range, rise time and fall time may be used to determine priority of clock signals for routing on an integrated circuit. For example, signals with faster rise times and/or fall times may be given priority for routing because the higher frequency components associated with the faster rise times and/or fall times may interfere with signals on other traces. Accordingly, if the priority signals are routed first, they may be able to be routed as shorter paths and/or isolated from other signals. Isolation may comprise, for example, placing other traces between the priority signals and other signals. Rise and fall times may be related to current output for a clock driver and to a capacitive load to that clock driver.

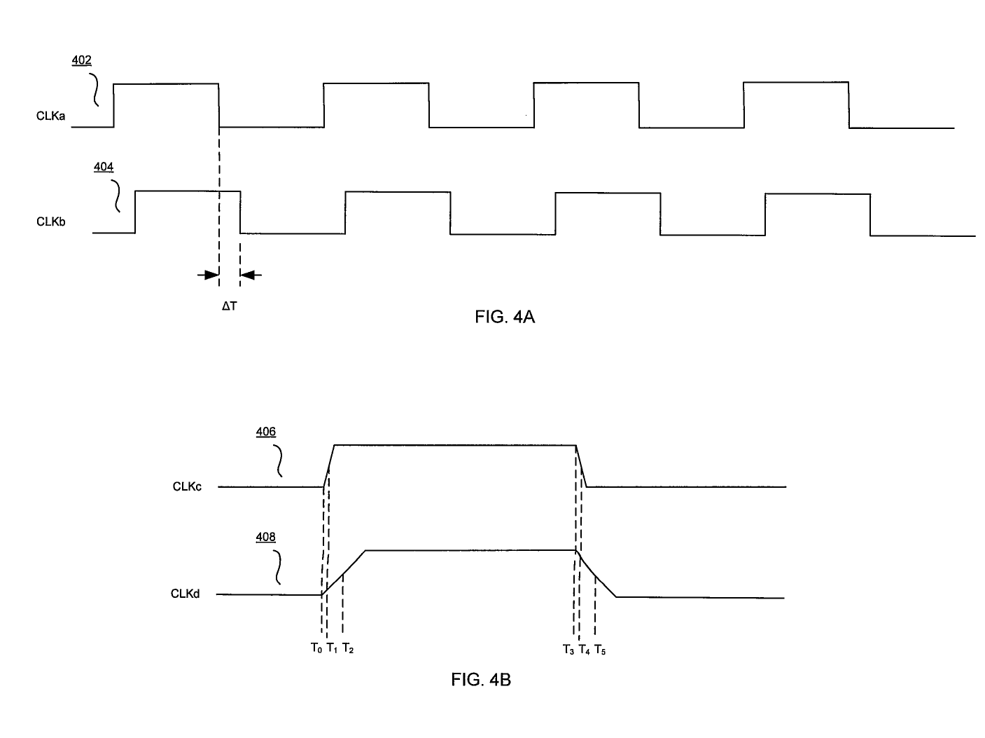

In an integrated circuit, increasing a number of loads that may have to be driven by a clock driver may increase a capacitive load for that clock driver. Similarly, increasing the length of trace paths for a signal may also add to the capacitive load for a clock driver. Since a clock driver may be current limited due to design of that clock driver, additional capacitive loads may increase rise and/or fall times to an unacceptable duration. For example, as the rise and/or fall times increase, the transition period from one logic state to the other logic state may increase. This may increase susceptibility of the signal to noise during the increased rise and/or fall times. For example, a receiving circuit may detect an incorrect logic state due to spurious noise received during the increased rise and/or fall times. This may affect whether the receiving circuit may determine whether the received signal may have transitioned from a low logic state to a high logic state, or vice versa. Rise time and fall time are discussed in more detail with respect to FIG. 4B.

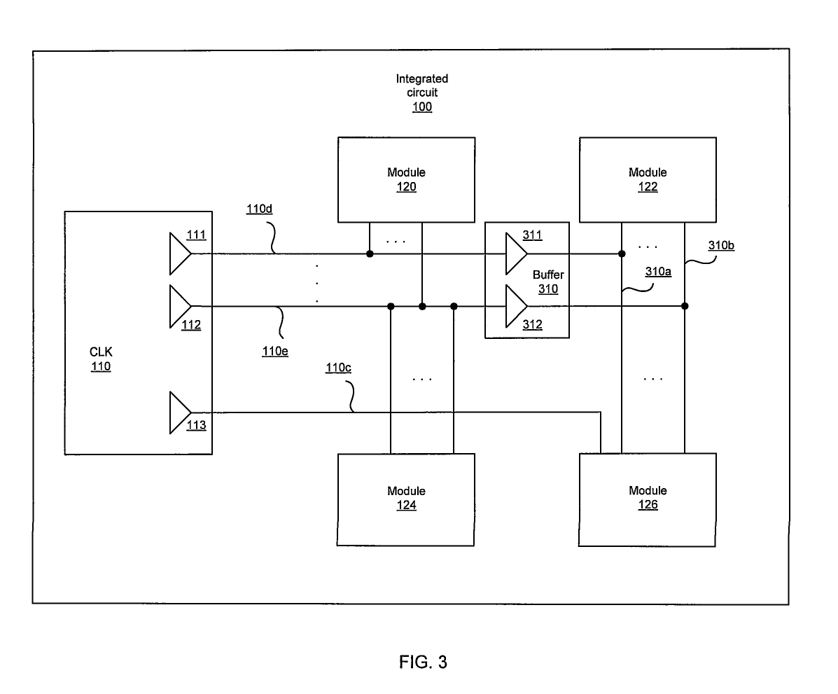

FIG. 3 is a block diagram illustrating an exemplary clock signal net in an integrated circuit, which may be utilized in connection with an embodiment of the invention. Referring to FIG. 3, there is shown an integrated circuit (chip) 100 that may comprise a clock generation block 110, and a plurality of circuit modules 120, 122, 124, . . . 126, and a buffer module 310. The buffer module 310 may comprise suitable logic and/or circuitry that may enable buffering of the plurality of clock signals 110c, 110d . . . 110e. For example, the buffer module 310 may comprise buffers 311 and 312. The clock signals 110d . . . 110e may be buffered, for example, by the buffer module 310 to keep rise times and/or fall times within desired limits. For example, a long layout trace for a clock signal terminating at multiple inputs to various circuitry may present a capacitive load that may be larger than can be handled adequately by a clock with a specified current driving capacity. Accordingly, the rise time and/or the fall time for that clock signal may be larger than desired as the clock buffer does not output enough current for the capacitive load.

Accordingly, to reduce capacitive loading for the buffers 111 . . . 112, the buffer module 310 may be used. The buffer module 310 may split clock trace routing to reduce the capacitive load to a clock driver. For example, rather than the clock driver 111 in the clock generation block 110 driving the loads in the circuit modules 120, 122, 124, . . . 126, use of the buffer module 310 may split the load to two circuits. Accordingly, the clock driver 111 may drive the load associated with the clock signal 110d, and the buffer 311 may drive the load associated with the clock signal 310a. The clock driver 112 may drive the load associated with the clock signal 110e, and the buffer 312 may drive the load associated with the clock signal 310b.

Furthermore, the capacitive load to, for example, the clock driver 111 may be related to the length of traces for the clock signal 110d. The capacitive load for the clock driver 111, 112, 311, and 312 may change, for example, as total length of traces for each of the clock signals 110d, 110e, 310a, and 310b, respectively, changes. Accordingly, layout design for the integrated circuit 100 may comprise using, for example, the buffers to reduce a total length of traces for clock signals in order to reduce the capacitive load to a clock driver to an acceptable level. The acceptable level may be determined by design criteria and/or layout criteria, for example.

In this manner, a clock signal generated by the clock generation block 110 may be communicated to the circuit modules 120, 122, 124, . . . 126 by the clock generation block 110 and/or the buffer module 310. Moreover, since capacitive load to each buffer in the clock generation block 110 and the buffer module 310 may be reduced, the rise and/or fall times for the clock signals 110c, 110d, 310a, and 310b may be within an acceptable limit for circuit design for the integrated circuit 100.

FIG. 4A illustrates an exemplary timing diagram for clock signals in an integrated circuit. Referring to FIG. 4A, there is shown a clock signal CLKa 402 and a clock signal CLKb 404. There may be a delay ΔT, or skew, between the clock signal CLKa 402 and the clock signal CLKb 404. The skew may be, for example, between the clock signal 110c and the clock signal 310a. The skew may be a result of the delay introduced by the buffer 311 to the clock signal 310a.

The logic modules 120, 122, 124, . . . , 126 may not be able to tolerate skew between, for example, two of the clock signals 110a . . . 110b, 110c beyond a specific amount, where the specific amount of skew that may be tolerated may be design and/or implementation dependent. Accordingly, it may be preferable to keep skew below a specific amount that may be design and/or implementation dependent. This may be accomplished, for example, by using a number of buffer stages for clock signals so as to keep skew within a specified amount. For example, rather than buffering only the clock signal CLKb 404, the clock signal CLKa 402a may also be buffered. This may reduce skew between the two clock signals, and may be performed even if the clock signal CLKa 402 may not need to be buffered for capacitive loading issues.

It may be preferable, therefore, to prioritize clock signals similarly that need to be synchronized with respect to each other. This prioritization, which may also depend on clock frequency, may be used to determine routing and buffering in order to reduce skew between the clock signals.

FIG. 4B illustrates an exemplary timing diagram for clock signals in an integrated circuit. Referring to FIG. 4B, there is shown a clock signal CLKc 406 and a clock signal CLKd 408. The clock signal CLKc 406 may be, for example, the clock signal 310a and the clock signal CLKd 408 may be, for example, the clock signal 110c. The capacitive loading for the clock signal CLKd 408 may be, for example, greater than the capacitive loading for the clock signal CLKc 406. Accordingly, the clock signal CLKc 406 may have faster rise times and/or fall times than the clock signal CLKd 408. The difference in the rise times and/or fall times between two signals may introduce an effective skew between the two signals.

For example, a circuit, such as the logic module 126, that may receive the clock signal CLKc 406 may determine that the clock signal CLKc 406 may have transitioned from a low logic state to a high logic state at time instant T₁. Similarly, the logic module 126 may determine that the clock signal CLKc 406 may have transitioned from a high logic state to a low logic state at time instant T₄. The exemplary clock signal CLKd 408, which may start to rise at the same time instant T₀ as the clock signal CLKc 406, may be determined to have transitioned from a logic low state to a logic high state at the time instant T₂. Accordingly, although there may not be a delay between the clock signals CLKc 406 and CLKd 408, there may be an effective delay due to different rise times.

Similarly, the exemplary clock signal CLKd 408, which may start to fall at the same time instant T₃ as the clock signal CLKc 406, may be determined to have transitioned from a logic high state to a logic low state at the time instant T₅. Accordingly, although there may not be a delay between the clock signals CLKc 406 and CLKd 408, there may be an effective delay due to different fall times. Accordingly, the clock signal CLKc 406 and the clock signal CLKd 408 may also be buffered in order that the clock signals CLKc 406 and CLKd 408 may have similar rise and/or fall times due to similar capacitive loading. This may reduce the effective skew between the two clock signals.

It may be preferable, therefore, to prioritize clock signals similarly that need to be synchronized with respect to each other. This prioritization, which may also depend on clock frequency, may be used to determine routing and buffering in order to reduce skew between the clock signals.

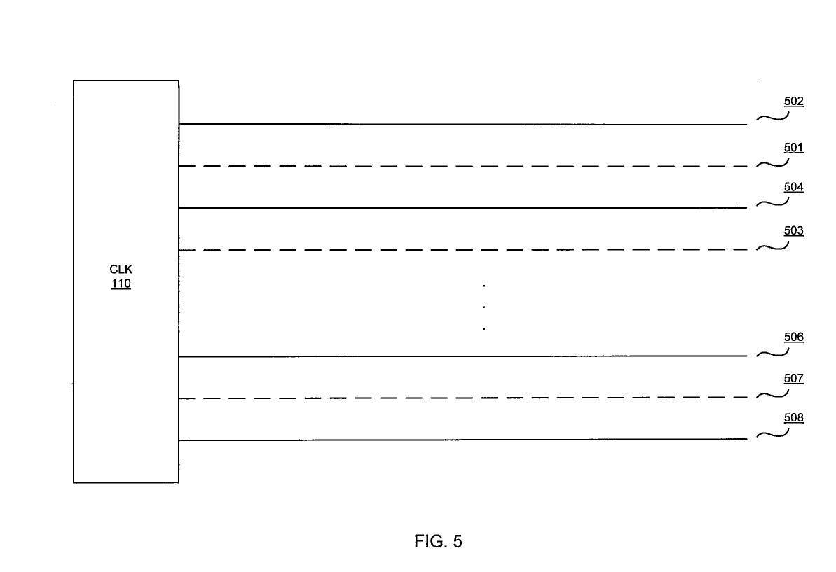

FIG. 5 illustrates an exemplary layout of clock signal paths in an integrated circuit, in accordance with an embodiment of the invention. Referring to FIG. 5, there is shown the clock generation block 110 and a plurality of clock signals 501 . . . 508. The clock signals 502, 504, 506, 508 may comprise, for example, functional clock signals, and the clock signals 501, 503, 505, 507 may comprise, for example, test clock signals. In the exemplary integrated circuit 100, for example, the functional clock signals 502, 504, 506, 508 may be active during a normal operation mode for the integrated circuit 100. The test clock signals 501, 503, 505, 507 may not be active during the normal operation mode for the integrated circuit 100. During a test mode for the integrated circuit 100, for example, scan test mode, the test clock signals 501, 503, 505, 507 may be active while the functional clock signals 502, 504, 506, 508 may not be active.

Accordingly, interlacing the functional clock signals 502, 504, 506, 508 with the test clock signals 501, 503, 505, 507 may provide isolation of the plurality of clock signals 501 . . . 508 from other traces that might emit interfering noise. However, because the functional clock signals 502, 504, 506, 508 and the test clock signals 501, 503, 505, 507 may not be active at the same time, the functional clock signals 502, 504, 506, 508 may not interfere with the test clock signals 501, 503, 505, 507, and vice versa. Additionally, in order to isolate the clock signals that may only be protected on one side, such as, for example, the functional clock signals 502 and 504, the unprotected side may be isolated from noise by using, for example, ground traces.

In one embodiment of the invention, it may be preferable, therefore, to prioritize functional clock signals and test clock signals similarly so that may be able to isolate each other. Notwithstanding, the invention may not be so limited. This prioritization, which may also depend on clock frequency, may be used to determine, for example, shortest-path routing for the similarly prioritized clock signals. Accordingly, by determining a scheme for laying out priority signals, layout area may be saved by not having to fit the priority signals around other signals traces that may previously have been laid out. A route guide may be generated where the route guide may be used to determine routing of various clocks signals and non-clock signals. The route guide may be based on, for example, cross-talk noise reduction desired, whether a metal layer is used for routing traces, and regional assignment of the various signals.

By reducing trace lengths for higher priority clock signals, and by interlacing the functional clock signals with test clock signals, the trace widths for the clock signals may not have to be increased nor extra padding space needed between clock traces. Increasing the trace widths may reduce capacitance per unit length of a trace, as well as decrease resistance per unit length of the trace. Extra padding space between traces may serve to reduce interference between signals propagating on the traces.

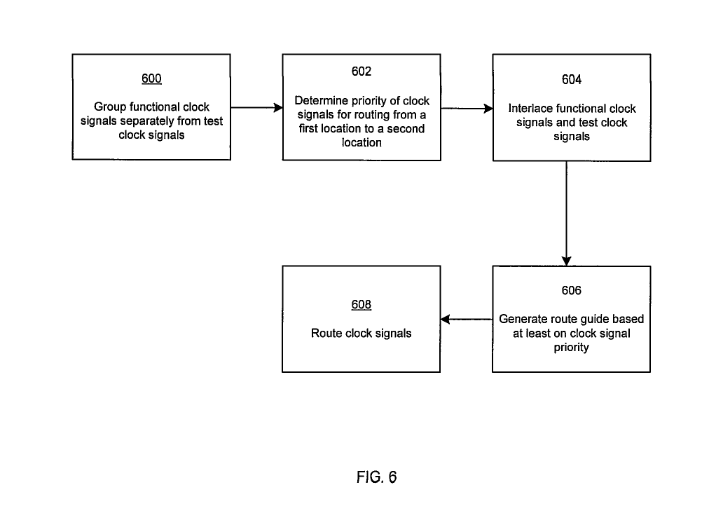

FIG. 6 is a flow chart illustrating exemplary steps for reducing coupling noise, reducing signal skew, and saving layout area, in accordance with an embodiment of the invention. Referring to FIG. 6, steps 600 to 608 are shown. In step 600, the functional clock signals 502, 504, 506, 508, for example, may be grouped separately from the test clock signals 501, 503, 505, 507, for example. This may allow the functional clock signals 502, 504, 506, 508 to be prioritized with respect to each other, and the test clock signals 501, 503, 505, 507 to be prioritized with respect to each other. Accordingly, the high priority functional clock signals may be laid out first to reduce trace path lengths from a source location to a destination location. The high priority test clock signals may then be interlaced between the functional clock signals. Accordingly, high priority clock signals, whether functional or test, may be laid out using shorter and/or straighter paths, and the test clock signals may help isolate the functional clock signals, and vice versa.

In step 602, priority of clock signals may be determined for routing from a first location to a second location. The priority may be based on, for example, a frequency of the clock signals and/or the slew rate of the clock signals. In some instances, a clock signal may be communicated to another buffer, such as, for example, the buffer module 310. In other instances, a clock signal may be communicated to various logic circuitry within logic modules, such as, for example, the logic modules 122 and 126. In these instances, priority may also take into account the fan-out of the clock signals since they may add to capacitive loading.

In step 604, the functional clock signals and the test clock signals may be arranged to interlace functional clock signals with test clock signals. In step 606, a route guide may be generated based at least on clock signal priority. The route guide may further be based on, for example, cross-talk noise reduction desired, whether a metal layer is used for routing traces, and regional assignment of the various clock signals. In step 608, the clock signals may be routed based on the route guide. Accordingly, higher priority clock signals may have shorter paths and/or straighter paths. In instances where there may be more functional clock signals than test clock signals, some of the lower priority functional clock signals may not be interlaced with test clock signals. That is, the lower priority functional clock signals may be adjacent to each other. In instances where it may not be desirable to have functional clock signals adjacent to each other, they may be interlaced with, for example, ground traces. Similar design decisions may be made if there are more test clock signals than functional clock signals.

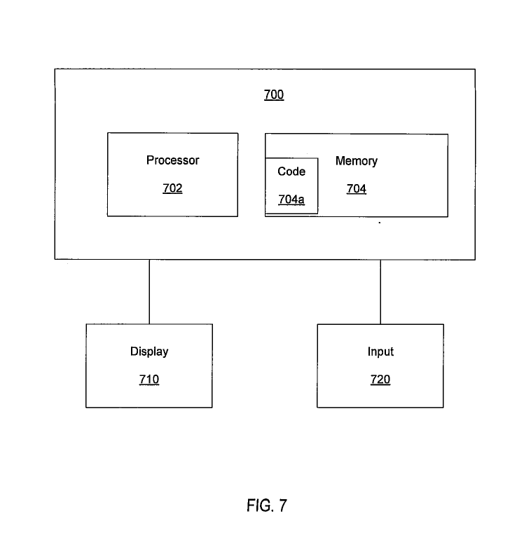

FIG. 7 is a block diagram of an exemplary processing system that may be used to lay out an integrated circuit, in accordance with an embodiment of the invention. Referring to FIG. 7, there is shown a processing system 700 that may be couple to a display unit 710 and input devices 720. The display unit 710 may comprise, for example, a video monitor. The input devices 720 may comprise, for example, a keyboard, a mouse, a trackball, and/or a digital-input tablet and a pen. The processing system 700 may comprise, for example, a processor 702 and a memory block 704. Code 702a may be stored, for example, in the memory block 702. The code 702a may comprise, for example, a program that may be used to layout traces for integrated circuits (ICs) and/or printed circuit (PC) boards.

The user may interact with the layout program via the input devices 720 in order to layout traces for the ICs and/or the PC boards. The processor 702 may execute instructions in the code 702a in view of the user input via the input devices 720 to layout traces for the circuitry of the IC or the PC board. The layout of the IC or the PC board may be displayed via the display 710.

In accordance with an embodiment of the invention, aspects of an exemplary system may comprise a layout processing device, such as, for example, the processing system 700, that enables prioritizing a plurality of clock signals on a chip. The processing system 700 may route the clock signals based on the prioritization of the clock signals. The clock signals may comprise, for example, the functional clock signals 502, 504, 506, . . . 508 and the test clock signals 501, 503, 505, . . . 507. The priority of a clock signal may be based on, for example, frequency and/or slew rate of that clock signal. An embodiment of the invention may assign, for example, higher priority to a functional clock signal than to the test clock signal.

The processing system 700 may also, for example, interlace trace routes for the functional clocks 502, 504, 506, . . . 508 with trace routes for the test clocks 501, 503, 505, . . . 507 during the routing. In an embodiment of the invention, a clock signal with a higher priority may be routed before other clock signals with lower priorities. The functional clocks 502, 504, 506, . . . 508 may be inactive during a period of time when the test clocks 501, 503, 505, . . . 507 may be active, and vice versa. Accordingly, by means of interlacing the clock signals, the functional clocks may help isolate the test clocks from interference when the test clocks are active. Similarly, when the functional clocks are active, the test clocks may help isolate the functional clocks from interference.

The processing system 700 may also utilize, for example, a route guide to determine trace routing of the clock signals. The route guide may be based on, for example, cross-talk noise reduction desired for the clock signals and/or the whether a metal layer may be used for routing the traces. The route guide may also be based on, for example, the fanout for each clock signal.

Another embodiment of the invention may provide a machine-readable storage, having stored thereon, a computer program having at least one code section executable by a machine, thereby causing the machine to perform the steps as described above for reducing coupling noise, reducing signal skew, and saving layout area for an integrated circuit.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will comprise all embodiments falling within the scope of the appended claims.

What is claimed is:

1. A method for layout design, the method comprising:
prioritizing on a chip a plurality of clock signals comprising functional clock signals and test clock signals;
routing said clock signals based on said prioritizing; and
interlacing on said chip, trace routes for said functional clocks with trace routes for said test clocks during said routing.

2. The method according to claim 1, wherein one of said plurality of clock signals is routed before another of said plurality of clock signals having a lower priority.

3. The method according to claim 1, wherein said functional clocks are inactive during at least a period of time when said test clocks are active.

4. The method according to claim 1, wherein said test clocks are inactive during at least a period of time when said functional clocks are active.

5. The method according to claim 1, wherein said functional clock signal has a higher priority than said test clock signal.

6. The method according to claim 1, wherein said prioritizing is based at least on a frequency of each of said plurality of clock signals.

7. The method according to claim 1, wherein said prioritizing is based at least on a slew rate of each of said plurality of clock signals.

8. The method according to claim 1, comprising utilizing a route guide to determine routing of each of said plurality of clock signals.

9. The method according to claim 8, wherein said route guide is based on cross-talk noise reduction desired for said plurality of clock signals.

10. The method according to claim 8, wherein said route guide is based on whether a metal layer is used for routing.

11. A machine-readable storage having stored thereon, a computer program having at least one code section for layout design, the at least one code section being executable by a machine for causing the machine to perform steps comprising:
prioritizing on a chip a plurality of clock signals comprising functional clock signals and test clock signals;
routing said clock signals based on said prioritizing; and
interlacing on said chip, trace routes for said functional clocks with trace routes for said test clocks during said routing.

12. The machine-readable storage according to claim 11, wherein said at least one code section comprises code for routing one of said plurality of clock signals before another of said plurality of clock signals having a lower priority.

13. The machine-readable storage according to claim 11, wherein said functional clocks are inactive during at least a period of time when said test clocks are active.

14. The machine-readable storage according to claim 11, wherein said test clocks are inactive during at least a period of time when said functional clocks are active.

15. The machine-readable storage according to claim 1 1, wherein said functional clock signal has a higher priority than said test clock signal.

16. The machine-readable storage according to claim 11, wherein said prioritizing is based at least on a frequency of each of said plurality of clock signals.

17. The machine-readable storage according to claim 11, wherein said prioritizing is based at least on a slew rate of each of said plurality of clock signals.

18. The machine-readable storage according to claim 11, wherein said at least one code section comprises code for utilizing a route guide to determine routing of each of said plurality of clock signals.

19. The machine-readable storage according to claim 18, wherein said route guide is based on cross-talk noise reduction desired for said plurality of clock signals.

20. The machine-readable storage according to claim 18, wherein said route guide is based on whether a metal layer is used for routing.

21. A system for layout design, the system comprising:
a layout processing device that enables prioritizing a plurality of clock signals on a chip, wherein said plurality of clock signals comprises functional clock signals and test clock signals;
said layout processing device enables routing of said clock signals based on said prioritizing; and
said layout processing device enables interlacing on said chip, trace routes for said functional clocks with trace routes for said test clocks during said routing.

22. The system according to claim 21, wherein one of said plurality of clock signals is routed before another of said plurality of clock signals having a lower priority.

23. The system according to claim 21, wherein said functional clocks are inactive during at least a period of time when said test clocks are active.

24. The system according to claim 21, wherein said test clocks are inactive during at least a period of time when said functional clocks are active.

25. The system according to claim 21, wherein said functional clock signal has a higher priority than said test clock signal.

26. The system according to claim 21, wherein said prioritizing is based at least on a frequency of each of said plurality of clock signals.

27. The system according to claim 21, wherein said prioritizing is based at least on a slew rate of each of said plurality of clock signals.

28. The system according to claim 21, wherein said layout processing device enables utilization of a route guide to determine routing of each of said plurality of clock signals.

29. The system according to claim 28, wherein said route guide is based on cross-talk noise reduction desired for said plurality of clock signals.

30. The system according to claim 28, wherein said route guide is based on whether a metal layer is used for routing.
